(19) United States
(12) Patent Application Publication
(10) Pub. No.: US 2003/0235687 A1
(43) Pub. Date: Dec. 25, 2003

(54) Folded paper tape

(76) Inventor: Bobbie Don Peacock, Peachtree City, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/442,702

(22) Filed: May 21, 2003

Related U.S. Application Data
(60) Provisional application No. 60/384,854, filed on May 30, 2002.

(51) Int. Cl. B32B 7/12

(52) U.S. Cl. 428/343

(57) ABSTRACT

A re-pulpable paper tape capable of use in paper pulp bailing applications is disclosed. The paper tape comprises a paper web having a first width, the paper web longitudinally folded to a final width that is less than the first width to form a folded paper tape; the folded paper tape having an outer surface and inside surfaces; and a re-pulpable adhesive applied to the paper web such that the adhesive covers substantially the entire inside surfaces of the folded paper tape, wherein the folded paper tape is strong enough to be used in paper pulp bailing applications. Methods of manufacturing folded paper tape capable of being used in paper pulp bailing applications are disclosed. Systems for bailing paper pulp utilizing folded paper tape are disclosed.

### CROSS REFERENCE TO RELATED APPLICATION

This application claims priority to U.S. Provisional Patent Application No. 60/384,854 filed May 30, 2002 entitled “Folded Paper Strapping Tape,” which is hereby incorporated in its entirety by this reference.

### FIELD OF THE INVENTION

The present invention relates generally to paper tape, and more particularly to re-pulpable folded paper tape.

### BACKGROUND

Paper tape or strap has long been used for cutting a continuous paper web during the process of paper manufacture when the web has to be transferred from a full roll to a roll core or mandrel to begin another roll. Paper tape has also been used for binding bales of pulp from which paper is made.

U.S. Pat. No. 4,414,258 to Corbin, Sr. describes one structure of paper tape. The tape disclosed by Corbin is comprised of a plurality of flat warp strips and weft filaments disposed in woven relation to each other. Another method of manufacture of paper tape is to wet and then twist strips of approximately one inch wide paper into strands. The strands are then positioned and bonded side-by-side into a tape that is one strand thick and, for example, fourteen to sixteen strands wide. The strips of paper from which the strands are twisted may be unbleached, natural color paper or bleached, white paper.

Another known type of paper tape is folded paper tape available, for example, from JUD Corporation, a subsidiary of IBS Holding GmbH. This folded paper tape is generally cheaper to manufacture than the woven and strand type tape discussed above and is made from a longitudinally folded strip of paper. The prior art folded paper tape is typically bonded into its folded configuration by a rubber-type adhesive. The use of such rubber-type adhesive is at least undesirable and may be entirely unacceptable in applications where the strapping needs to be thoroughly re-pulpable. Further, rubber-type adhesive does not add strength to the paper.

While it is important that paper tape used in bailing or turn-up procedures be thoroughly re-pulpable, this is especially important in the bailing context. Bale strapping tape utilized for bailing paper pulp to be used in making paper is ideally thoroughly re-pulpable, so that the bail strapping tape does not have to be removed from the bail of pulp when the bail is entered into the paper making process. Conventional turn-up tapes are generally not adequately re-pulpable. Consequently, there is a need for increasing the re-pulpability of paper tape.

Additionally, paper tape used in the bailing context should be capable of being joined, preferably with a heat joint, and should be strong enough to secure the paper tape around the bail. The prior art folded paper tape has a propensity to tear when joined in a bailing application. This is caused because the tensile strength at the joint of the prior art folded paper tape is only as strong as the tensile strength of the outer layers due to the uneven application of adhesive to the inner layers and the rubber-type adhesive used. Prior art paper tape also does not contain adhesive on the outer surfaces of the tape. Therefore, there is a need for a folded paper tape that is capable of being joined so that it can be used in the bailing context.

Furthermore, while the exact dimensions of paper tape typically are not critical, some of the equipment used in applying bale strapping cannot accommodate a very wide range of tape geometries. In particular, tapes having portions thicker or wider than particular dimensions may not be usable or may at least be undesirable for use in bale strapping. Accordingly, there is a need for techniques for controlling the thickness and width of strapping used to bind bales of paper.

### SUMMARY OF THE INVENTION

Methods, apparatuses and systems of this invention seek to provide a folded paper tape. The paper tape of the invention is re-pulpable and capable of use in paper pulp bailing applications. More particularly, the paper tape of the invention is formed from longitudinally folding a paper web and utilizes re-pulpable adhesive that is applied such that the adhesive covers substantially the inside surfaces of the folded paper tape and adhesive is applied to at least one outer surface of the paper tape. In one embodiment, the paper web is longitudinally folded three times. Another aspect of the invention is a method of manufacturing a folded paper tape capable of being used in paper pulp bailing applications. An additional aspect of the invention is a system utilizing folded paper tape for bailing paper pulp.

According to the invention there is provided a paper tape, comprising: a paper web having a first width, the paper web longitudinally folded to a final width that is less than the first width to form a folded paper tape; the folded paper tape having an outside surface and inside surfaces; and a re-pulpable adhesive applied to the paper web such that the adhesive covers substantially the entire inside surfaces of the folded paper tape, wherein the folded paper tape is strong enough to be used in paper pulp bailing applications.

According to the invention there is provided a method of manufacturing paper tape, from a paper web having a first width, capable of being used in paper pulp bailing applications, comprising: applying re-pulpable adhesive to the paper web; and longitudinally folding the paper web to a final width that is less than the first width to form folded paper tape, the folded paper tape having inside surfaces and an outer surface, wherein the adhesive is applied such that the adhesive substantially covers the inside surfaces of the folded paper tape and wherein the folded paper tape is strong enough to be used in paper pulp bailing applications.

### BRIEF DESCRIPTION OF THE DRAWINGS

The teachings of the present invention can be readily understood considering the following detailed descriptions in conjunction with the accompanying drawings, in which:

FIG. 1 depicts one embodiment of folded paper tape of the present invention;

FIG. 2 illustrates the folded paper tape used in a paper pulp bailing application;

FIG. 3 illustrates a paper web in a tri-fold;

FIG. 4 illustrates the paper web in a first double-fold;

FIG. 5 illustrates the paper web in a second double-fold;

FIG. 6 illustrates a perspective view of the tri-fold folding operation;

FIG. 7 illustrates an overhead view of the tri-fold folding operation;

FIG. 8 illustrates a perspective view of the first double-fold folding operation;

FIG. 9 illustrates a perspective view of the second double-fold folding operation.

### DETAILED DESCRIPTION

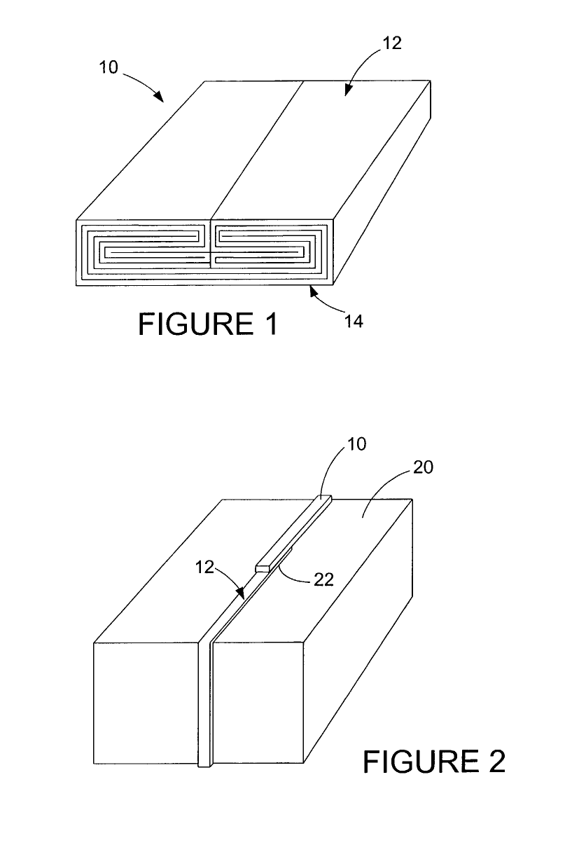

FIG. 1 illustrates a folded paper tape 10 according to one embodiment of this invention. The folded paper tape 10 is manufactured by a series of three folding operations along with the application of adhesive before each of the folding operations. In one embodiment, a paper web approximately 8 mils thick and having no chemical additives that would inhibit re-pulpability, is used. The folding operations according to one embodiment of the invention are a tri-fold operation followed by two double-fold operations and are explained in more detail below. Although any number of folding operations could be performed in a variety of different ways as is known by one skilled in the art. The resulting folded paper tape is approximately 0.75 inches in width, as this is the standard size for most paper pulp bailing equipment. Other widths are possible as known to those skilled in the art. An example of a paper pulp bailing system is U.S. Pat. No. 6,546,696, which is hereby incorporated in its entirety by this reference.

The adhesive of the present invention is re-pulpable and is applied throughout the folds so that the inner surfaces of the paper tape 10 are substantially covered with adhesive. This differs from the prior art folded paper tapes where the adhesive is not applied to substantially cover the inner surfaces of the paper tape and the adhesives used with the prior art are typically a rubber-type. This makes the prior art tape unsuitable for paper pulp bailing applications, because it has a tendency to tear when joined to secure the bail and the adhesive typically used is not re-pulpable. Adhesive is also applied to top outer surface 12 and/or bottom outer surface 14. In one embodiment, this adhesive is a heat sensitive adhesive.

FIG. 2 illustrates the folded paper tape 10 used on a paper pulp bail 20. The joint 22 used in one embodiment is also shown. In this embodiment, a heat sensitive adhesive is applied to the top outer surface 12 of the folded paper tape 10 and a heat seal is used to join the two ends of the tape. Other methods can be used as known to those skilled in the art.

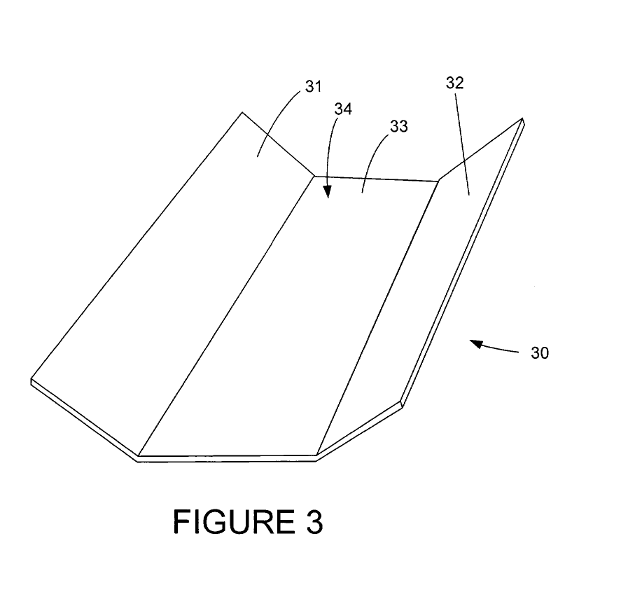

FIGS. 3-5 illustrate one embodiment of the folds used in the folding operations. Other folds could be used as known to those skilled in the art and more or less folds could be performed. FIGS. 3-5 illustrate a single paper web. Two or more paper webs could be used to form the folded paper tape. FIG. 3 illustrates the tri-fold. During the tri-fold operation two sides 31, 32 of a paper web 30 are folded down on a bottom side 33 of the paper web 30. This forms a first inside surface 34. The two sides 31, 32 and the bottom side 33 are substantially the same width, so as to decrease the width of the paper web 30 by two thirds. In one embodiment, the paper web has a width of 9 inches, so that the two sides 31, 32 and the bottom side 33 each have a width of 3 inches. In this embodiment, after the tri-fold operation the width of the paper web is 3 inches.

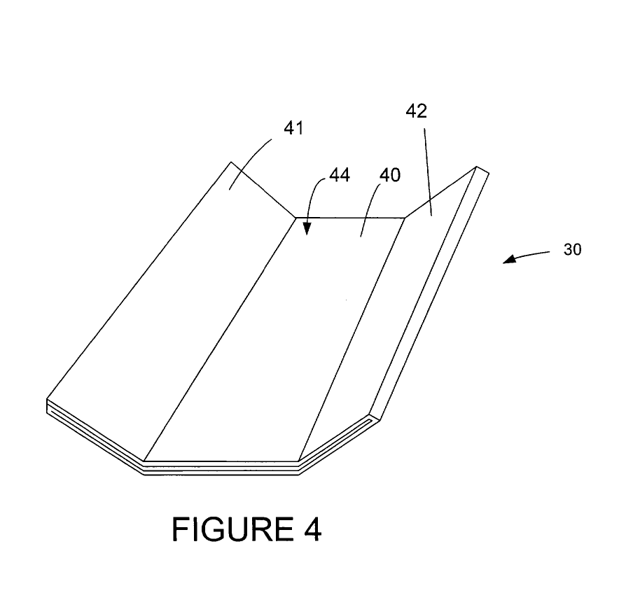

FIG. 4 illustrates the first double-fold. During the double-fold operation two sides 41, 42 are folded down on bottom side 40 of the paper web 30. This forms a second inside surface 44. The two sides 41, 42 are half the width of the bottom side 40 and are folded so that the two sides abut one another in the center of the bottom side 40. In this embodiment, the bottom side 40 is 1.5 inches and the two sides 41, 42 are 0.75 inches, so that the overall width of the paper web after the first double-fold operation is 1.5 inches.

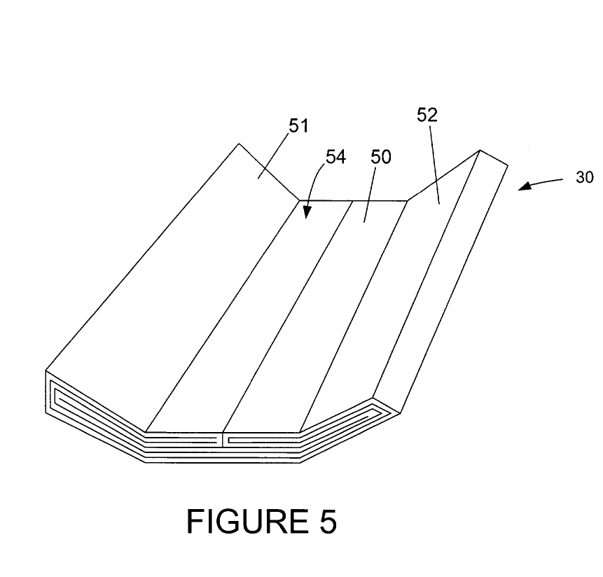

FIG. 5 illustrates the second double-fold. During the second double-fold operation two sides 51, 52 are folded down on bottom side 50 of the paper web 30. This forms a third inside surface 54. The two sides 51, 52 are half the width of the bottom side 50 and are folded so that the two sides abut one another in the center of the bottom side 50. In this embodiment, the bottom side 50 is 0.75 inches and the two sides 51, 52 are 0.325 inches, so that the overall width after the second double-fold operation is 0.75 inches.

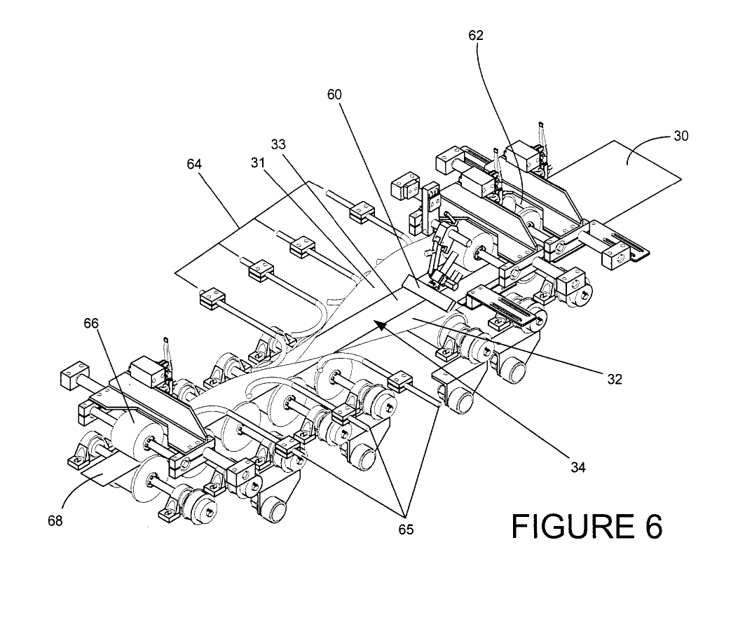

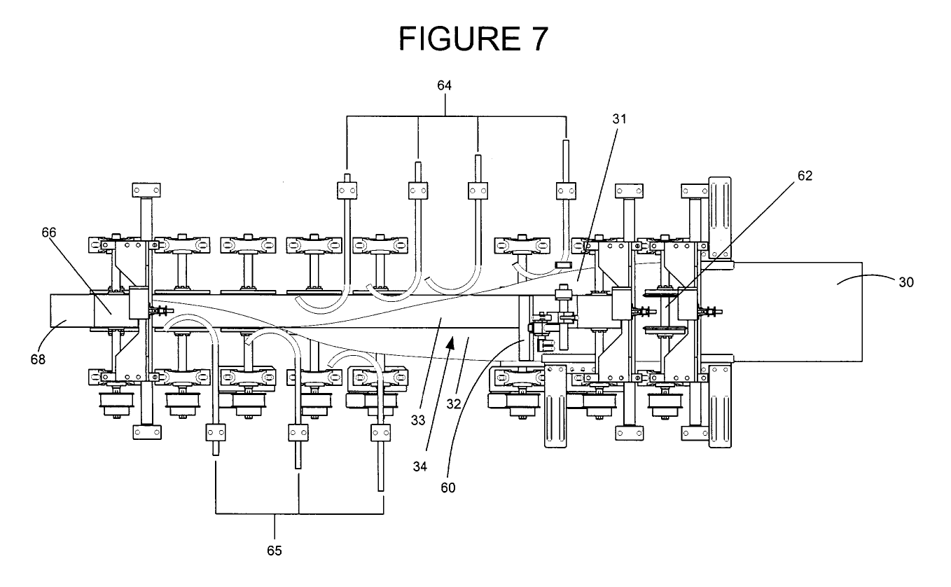

FIGS. 6-9 illustrate one embodiment of manufacturing the folded paper tape. FIGS. 6 and 7 illustrate the tri-fold operation. A paper web 30 first goes through score roller assembly 62. The score roller assembly 62 scores the paper web 30 to create the first side 31, the second side 32 and bottom side 33. First guide bars 64 then begin to fold the first side 31 onto the bottom side 33. A glue head assembly applies adhesive to the first inside surface 34 of the bottom side 33 and the second side 32. Rather than a rubber-type cement, an adhesive suitable for re-pulpability is used. In one embodiment, a polyvinyl alcohol adhesive is used. The polyvinyl alcohol acts to strengthen the paper web as well as an adhesive. Second guide bars then begin to fold the second side 32 onto the first side 31. The paper web then travels through compression rollers 66 so that the first side 31 is folded on to the bottom side 33 and the second side 32 is folded onto the first side producing a tri-folded paper web 68. Due to the application of adhesive over all of the first inside surface 34 of the bottom side 33 and the second side 32 during the tri-fold operation, adhesive substantially covers the first inside surface 34 of the tri-folded paper web 68.

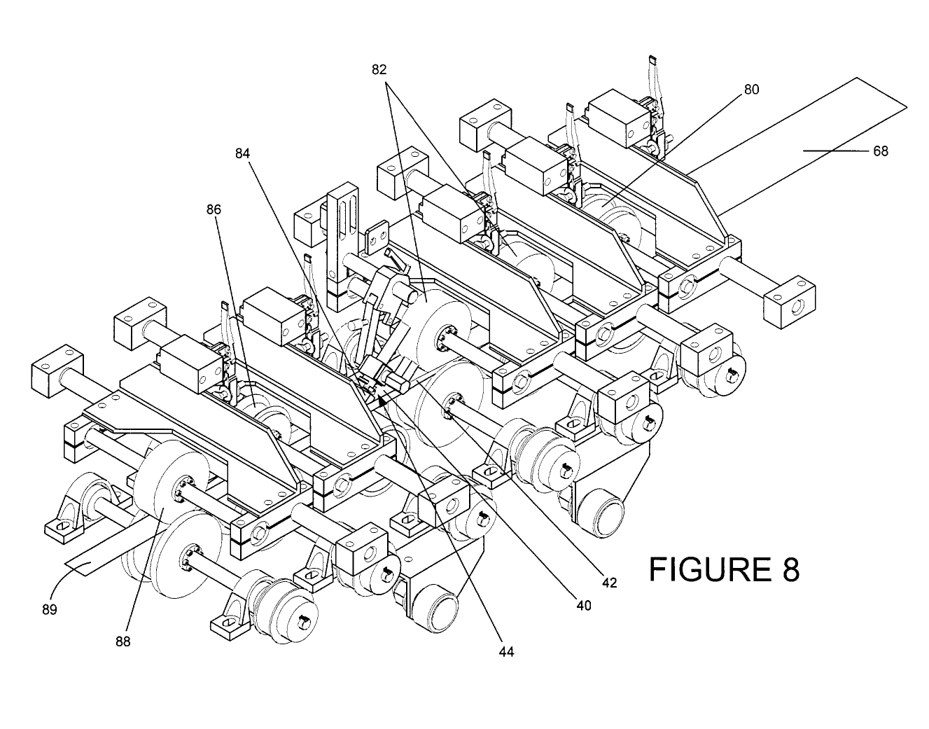

FIG. 8 illustrates the first double-fold operation. In this operation, the tri-folded paper web 68 first contacts score rollers 80. The score rollers 80 score the tri-folded paper web 68 to create the two sides 41, 42 and the bottom side 40. The tri-folded paper web 68 then goes through folder rollers 82, which fold the two sides 41, 42 substantially perpendicular to the bottom side 40. A glue assembly 84 then applies re-pulpable adhesive on the second inside surface 44 of the bottom side 40. Turn-in rollers 86 then act to turn-in the two sides 41, 42 toward the bottom side 40. The tri-folded paper web 68 then travels through compression rollers 88 so that the two sides 41, 42 are folded on to the bottom side 40 producing a double-folded paper web 89. Due to the application of adhesive over all of the second inside surface 44 of the bottom side 40 and the previous application of adhesive, adhesive substantially covers the first and second inside surfaces 34, 44 of the double-folded paper web 89.

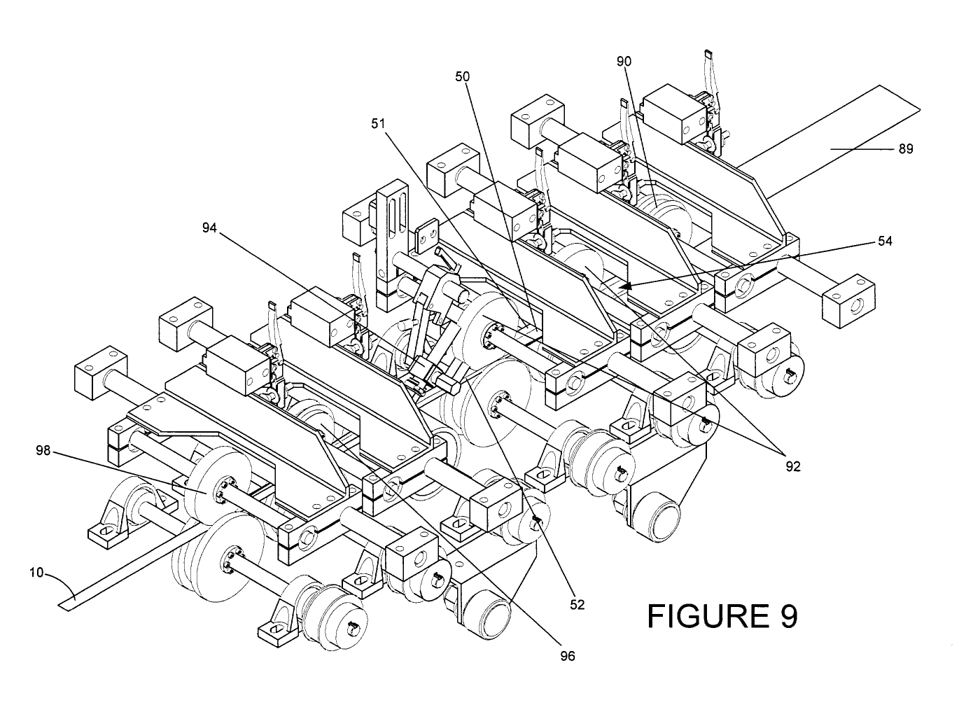

FIG. 9 illustrates the second double-fold operation. This operation operates in a similar way to the first double-fold operation. In this operation, the double-folded paper web 89 first contacts score rollers 90. The score rollers 90 score the double-folded paper web 89 to create the two sides 51, 52 and the bottom side 50. The double-folded paper web 89 then goes through folder rollers 92, which fold the two sides 51, 52 substantially perpendicular to the bottom side 50. A glue assembly 94 then applies re-pulpable adhesive on the third inside surface 54 of the bottom side 50. Turn-in rollers 96 then act to turn-in the two sides 51, 52 toward the bottom side 50. The double-folded paper web 89 then travels through compression rollers 98 so that the two sides 51, 52 are folded on to the bottom side 50 producing the folded paper web 10. Due to the application of adhesive over all of third inside surface 54 of the bottom side 50 and the previous applications of adhesive, adhesive substantially covers the inside surfaces 34, 44, 54 of the folded paper tape 10.

In one embodiment, the compression rollers 98 are grooved to emboss the surface with parallel, longitudinal grooves, thereby imparting a surface shape similar to the surface of conventional turn-up and strapping tape made from parallel strands of twisted paper. The compression rollers 98 as well as the previous compression rollers 66, 88 also help maintain a desired thickness of the folded paper tape. Paper tape preferably is 0.043-0.045 inches thick at all points. In another embodiment, side compression rollers are used to maintain a desired width of the folded paper tape. A typical desired tape width is 0.750 inches, and an acceptable range of widths is 0.735-0.760 inches.

In one embodiment, adhesive is applied to the top outer surface 12 of the folded paper tape 10 so that the two ends of the folded paper tape can be joined together as used in a bailing application for paper pulp bails. In one embodiment, a heat sensitive adhesive is used and heat sealing is used to make the joint from the two strap ends, as shown in FIG. 2.

Modifications can be made in the tape or strap of this invention without departing from the scope or spirit of this invention. For instance, different weights of paper can be used, and different dimensions of tape can be produced. Additionally, other adhesives could be used, including different adhesives on the inside surfaces of the tape to hold it in its folded position and on the outside of the strap for bonding tape ends, provided that the properties described above are achieved. Alternative folding operations can also be employed.

What is claimed is:

1. A paper tape, comprising:
a paper web having a first width, the paper web longitudinally folded to a final width that is less than the first width to form a folded paper tape;
the folded paper tape having an outer surface and inside surfaces; and
a re-pulpable adhesive applied to the paper web such that the adhesive covers substantially the entire inside surfaces of the folded paper tape,
wherein the folded paper tape is strong enough to be used in paper pulp bailing applications.

2. The paper tape of claim 1 wherein an adhesive is applied to the outer surface.

3. The paper tape of claim 1 wherein the folded paper tape is formed by three longitudinal folding operations.

4. The paper tape of claim 3 wherein the three folding operations are a tri-fold operation and two double-fold operations.

5. The paper tape of claim 4 wherein adhesive is applied during each folding operation.

6. The paper tape of claim 1 wherein the paper web is comprised of a plurality of webs of paper.

7. The paper tape of claim 1 wherein the first width is nine inches.

8. The paper tape of claim 1 wherein the final width is 0.75 inches.

9. The paper tape of claim 1 wherein the paper tape is capable of being joined together through heat sealing when used in a bail strapping application.

10. The paper tape of claim 1 wherein the paper tape is between 0.043 to 0.045 inches thick at all points.

11. The paper tape of claim 1 wherein the final width is between 0.735 to 0.76 inches.

12. The paper tape of claim 1 wherein the paper tape is capable of being used in turn-up tape applications.

13. The paper tape of claim 1 wherein the folded paper tape has parallel longitudinal grooves embossed on the outside surface.

14. A method of manufacturing paper tape, from a paper web having a first width, capable of being used in paper pulp bailing applications, comprising:
applying re-pulpable adhesive to the paper web; and
longitudinally folding the paper web to a final width that is less than the first width to form folded paper tape, the folded paper tape having inside surfaces and an outer surface,
wherein the adhesive is applied such that the adhesive substantially covers the inside surfaces of the folded paper tape and wherein the folded paper tape is strong enough to be used in paper pulp bailing applications.

15. The method of claim 14 further comprising applying adhesive to the outer surface of the paper tape.

16. The method of claim 14 wherein the folded paper tape is formed by three longitudinal folding operations.

17. The method of claim 16 wherein the three folding operations are a tri-fold operation and two double-fold operations.

18. The method of claim 16 wherein adhesive is applied during each folding operation.

19. The method of claim 14 further comprising embossing the outside surface of the folded paper tape with parallel longitudinal grooves.

20. The method of claim 14 further comprising controlling the thickness of the paper tape by using compression rollers.

21. The method of claim 14 further comprising controlling the width of the paper tape by using compression rollers.

22. A paper pulp bailing system, comprising:
a bailer capable of bailing paper pulp;
paper tape bail strapping comprising;
a paper web having a first width, the paper web longitudinally folded to a final width that is less than the first width to form a folded paper tape;
the folded paper tape having an outside surface and inside surfaces; and
a re-pulpable adhesive applied to the paper web such that the adhesive covers substantially the entire inside surfaces of the folded paper tape,
wherein the folded paper tape is strong enough to be used in paper pulp bailing applications.

23. The paper pulp bailing system of claim 22 wherein an adhesive is applied to the outer surface of the folded paper tape.

24. The system of claim 22 wherein the folded paper tape is formed by three longitudinal folding operations.
